(19) United States
(12) Patent Application Publication
(10) Pub. No.: US 2005/0167286 A1
(43) Pub. Date: Aug. 4, 2005

(54) Chemical reactor for nitrogen oxide removal and method of removing nitrogen oxide

(75) Inventors: Masanobu Awano, Aichi (JP); Yoshinobu Fujishiro, Aichi (JP); Jin Hwang Hae, Aichi (JP); Sergei Bredikhin, Aichi (JP); Kazuyuki Matsuda, Aichi (JP); Shingo Katayama, Aichi (JP); Motoyuki Miyata, Aichi (JP); Kunihiro Maeda, Aichi (JP); Takuya Hiramatsu, Aichi (JP); Osamu Shiono, Aichi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Nat'l Inst of Advanced Industrial Sci and Tech, Tokyo (JP)

(21) Appl. No.: 10/506,620

(22) PCT Filed: Mar. 17, 2003
(86) PCT No.: PCT/JP03/03178

(30) Foreign Application Priority Data
Mar. 15, 2002 (JP) 2002-073089
Mar. 18, 2002 (JP) 2002-073437
Jul. 12, 2002 (JP) 2002-204893
Jul. 12, 2002 (JP) 2002-204318

(51) Int. Cl. B01D 59/40; C25D 17/00

(52) U.S. Cl. 205/765; 204/252

(57) ABSTRACT

The present invention provides a chemical reactor with which nitrogen oxide emission control can be performed very efficiently at a low applied voltage when an excess of oxygen is present in a combustion exhaust gas. The present invention is a chemical reactor in which the upper cathode, lower cathode, and anode that make the chemical reactor are a mixture of an electron-conductive substance and an ion-conductive substance, and the electron-conductive substance and ion-conductive substance of the upper cathode are mixed in a specific ratio, which makes it possible to lower the applied voltage and reduce the power consumption of the chemical reactor, and is also a method for the emission control of nitrogen oxides in which this chemical reactor is used.

### TECHNICAL FIELD

This invention relates to a chemical reactor for nitrogen oxide emission control, and more particularly relates to a chemical reactor for the efficient emission control of nitrogen oxides from a combustion exhaust gas in which there is an excess of oxygen that would hamper a chemical reaction for nitrogen oxide emission control, and to a method for nitrogen oxide emission control by using this chemical reactor.

This invention also relates to a chemical reactor having a specific electrode layer, and more particularly relates to the structure of an electrochemical cell type of chemical reactor for subjecting a treatment substance to a chemical reaction, in which the structure of the path over which electrons are supplied for ionizing elements, and the path for excluding ionized elements from the catalyst reaction surface is optimized; for example, the emission control of nitrogen oxides from a combustion exhaust gas that contains oxygen can be performed efficiently and at low power consumption.

This invention also relates to a nitrogen oxide removal method and removal system in which nitrogen oxide emission control is performed, and more particularly relates to a nitrogen oxide removal method and removal system with which the nitrogen oxides in an exhaust gas emitted from a combustor such as a lean engine or a diesel engine that is frequently started and stopped can be reliably removed while the exhaust gas is still at a low temperature immediately after the combustor has been started up.

Further, this invention relates to a chemical reactor, and more particularly relates to a chemical reactor that allows the efficient emission control of nitrogen oxides from a combustion exhaust gas that contains oxygen, for example, in a chemical reactor that includes an ion-conductive phase composed of a solid electrolyte for subjecting a treatment substance to a chemical reaction. The present invention is useful in that it provides a chemical reactor with a novel structure that blocks the electrical conduction path to a chemical reaction component surface where oxygen is adsorbed, and thereby inhibits the ionization reaction of adsorbed oxygen at the chemical reaction component surface, and making it possible to treat a treatment substance more efficiently and at a lower power consumption.

### BACKGROUND ART

The emission control of nitrogen oxides generated by gasoline engines is today primarily handled with a three-way catalytic converter. However, since there is an excess of oxygen in the combustion exhaust gas emitted from diesel engines and lean engines that afford better fuel economy, the adsorption of oxygen at the surface of the three-way catalytic converter results in a sharp drop-off in catalyst activity, to the point that nitrogen oxide emission control becomes impossible.

Consequently, one method for removing the oxygen from a catalyst surface has been to intermittently introduce hydrocarbons in order to react with the oxygen and release it to outside the system, but this inevitably leads to higher fuel consumption.

Meanwhile, another approach has been to use solid electrolyte membrane having oxygen ion conductivity, and pass current through this membrane so that the oxygen in the exhaust gas is removed without being adsorbed to the catalyst surface. One system that has been proposed as a catalyst reactor decomposes nitrogen oxides into oxygen and nitrogen and simultaneously removes surface oxygen by applying voltage to a solid electrolyte sandwiched between electrodes.

Prior publications here include (1) J. Electrochemical Soc., 122, 869 (1975), which states that nitrogen oxides are decomposed into nitrogen and oxygen by applying voltage to platinum electrodes formed on both sides of zirconia that has been stabilized with scandium oxide, and (2) J. Chem. Soc. Faraday Trans., 91, 1995 (1995), which states that nitrogen oxides are decomposed into nitrogen and oxygen in a mixed gas of nitrogen oxide, hydrocarbon, and oxygen by applying voltage to palladium electrodes formed on both sides of zirconia that has been stabilized with yttrium oxide.

With the above conventional methods, however, if an excess of oxygen is present in the combustion exhaust gas, the oxygen will be preferentially ionized at the electrodes and flow through the solid electrolyte, so a larger amount of current is required in order to decompose the nitrogen oxides, which means that a higher voltage has to be applied and power consumption is higher, and this poses a major obstacle to practical use.

Also, with an electrochemical cell that makes use of a solid electrolyte membrane, nitrogen oxides can indeed be decomposed or removed merely by applying voltage, but a problem is that the temperature has to be high (400° C. or higher) in order to increase the ion conductivity of the solid electrolyte. Also, particularly when the exhaust gas is cold immediately after the combustor has been started up, the above-mentioned electrochemical cell does not exhibit adequate performance, and nitrogen oxides cannot be removed for a time, and this problem is particularly pronounced with diesel engines, lean engines, and so forth that are frequently started and stopped.

In the midst of this situation, the inventors discovered that with a chemical reactor that includes an ion-conductive phase composed of a solid electrolyte for subjecting a treatment substance to a chemical reaction, the treatment substance can be treated more efficiently and at lower power consumption by disposing the catalyst reaction component in the upstream part of the chemical reaction component, and utilizing a catalytic reaction to reduce the excess oxygen that would otherwise be a harmful gas in the chemical reaction of the treatment substance (Japanese Patent Application 2001-223687). A problem with this method, however, was that a reducing agent such as a hydrocarbon was needed to reduce excess oxygen, which hampered efforts at energy conservation.

### DISCLOSURE OF THE INVENTION

In view of this, and in an effort to solve the above problems, the inventors conducted research aimed at developing technology for reducing the amount of oxygen that is ionized at the cathode of an electrochemical cell, even when an excess of oxygen is present in a combustion exhaust gas, and thereby developing technology for decreasing the resistance of an electrochemical cell and at the same time reducing the amount of current needed to decompose nitrogen oxides, and reducing the applied voltage. Specifically, it is an object of the first aspect of the present invention to provide a chemical reactor with which the amount of current required to decompose nitrogen oxides is reduced by decreasing the amount of oxygen that is ionized and flows through an electrochemical cell, even when there is an excess of oxygen present in a combustion exhaust gas, and the resistance of the electrochemical cell is also lowered, which allows the applied voltage to be reduced and nitrogen oxide emission control to be performed at higher efficiency and lower power consumption.

Also, the present invention was conceived in order to solve the above problems, and the inventors arrived at the present invention upon discovering that the stated object can be achieved, and a treatment substance can be treated at higher efficiency and lower power consumption, by disposing an electrode layer composed of a mixture of an ion conductor and an electron conductor at the lower portion where the chemical reaction occurs, and optimizing the mix ratio of the ion conductor and the electron conductor so that the supply of electrons with respect to the oxygen that serves as the active site of the chemical reaction, and the process of moving and removing the ionized oxygen can be carried out more efficiently.

Specifically, it is an object of the second aspect of the present invention to provide a novel chemical reactor that fundamentally solves the problems with the above prior art, which makes possible 1) the optimization of the structures of the path for supplying electrons that ionize oxygen and of the path for eliminating ionized oxygen from the catalyst reaction surface, and 2) the resulting decrease in the electrical power needed to decompose nitrogen oxides with an electrochemical cell process, and perform nitrogen oxide emission control at higher efficiency and lower power consumption.

Also, in light of the above prior art, the inventors conducted diligent research aimed at fundamentally solving all the problems encountered with the above prior art and developing a novel nitrogen oxide removal method and removal system with which the nitrogen oxides in an exhaust gas can be reliably removed when the exhaust gas is still cold immediately after the combustor has been started up, and discovered in the course of this research that the stated object can be achieved by providing to the upstream part of an electrochemical cell a nitrogen oxide adsorption component composed of a nitrogen oxide adsorption material that adsorbs nitrogen oxides at low temperatures from room temperature to 400° C. and releases nitrogen oxides at high temperatures over 400° C. Further research led to the perfection of the present invention.

Specifically, the third aspect of the present invention was conceived with the technological goal of ameliorating the problems encountered with technology for removing nitrogen oxides from an exhaust gas with the above-mentioned electrochemical cell, and it is an object thereof to provide a method and a system for reliably removing the nitrogen oxides in an exhaust gas when the exhaust gas is still cold immediately after the combustor has been started up.

Further, in light of the above prior art, the inventors conducted diligent research aimed at fundamentally solving these problems, and as a result discovered that the uppermost layer surface accounts for a considerable portion of the oxygen adsorption in a chemical reaction component, the ionization and removal of this adsorbed oxygen consume a large amount of current, and blocking the electrical conduction path to the chemical reaction component surface where the oxygen has been adsorbed from the lower part of an electron-conductive electrode is an effective way to reduce the consumption of current in the removal of this surface oxygen. Further research led to the perfection of the present invention.

Specifically, the goal of the present invention is to solve the above problems, and it is an object of the fourth aspect of the present invention to provide a chemical reactor with a novel structure with which the amount of current needed to decompose nitrogen oxides can be reduced, and nitrogen oxide emission control can be performed at higher efficiency and lower power consumption, by reducing the amount of oxygen that is ionized and flows through the solid electrolyte when an excess of oxygen is present in a combustion exhaust gas, with a chemical reactor that includes an ion-conductive phase composed of a solid electrolyte for subjecting a treatment substance to a chemical reaction.

The first aspect of the present invention will now be described in detail.

The present invention is a chemical reactor for nitrogen oxide emission control, with this chemical reactor being characterized in the composition of the constituent materials of the electrochemical cell that makes up the chemical reactor. The present invention was conceived on the basis of new knowledge discovered by the inventors, namely, that by setting the compositional ratio of the electron-conductive substance and ion-conductive substance that are the constituent materials of the upper cathode (catalyst reaction component) in the above-mentioned chemical reactor to within a specific range, 1) the nitrogen oxide emission control rate increases critically, and 2) this allows for a large decrease in power consumption and applied voltage. Specifically, in the present invention, the volumetric ratio of the electron-conductive substance and ion-conductive substance that make up the upper cathode is selected from a range of 3:7 to 7:3, and preferably 3:7 to 5:5, the result of which is that there is a specific increase in the nitrogen oxide emission control rate, power consumption is reduced, and there is a decrease in the resistance of the chemical reactor, leading to a reduction in applied voltage. Thus, the present invention was developed on the basis of the new discovery that the nitrogen oxide emission control rate is specifically increased by selecting the constituent materials of the electrochemical cell that makes up the above-mentioned chemical reactor so that the compositional ratio of the constituent materials of the upper cathode (catalyst reaction component) is within a specific ratio.

Examples of the electron-conductive substance used for the upper cathode include gold, silver, platinum, palladium, nickel, and other such metals, and cobalt oxide, nickel oxide, copper oxide, lanthanum chromite, lanthanum manganite, lanthanum cobaltite, and other such metal oxides. An oxygen ion-conductive substance can be used preferably as the ion-conductive substance. The oxygen ion-conductive substance can be zirconia stabilized with yttrium oxide or scandium oxide, ceria stabilized with gadolinium oxide or samarium oxide, lanthanum gallate, or the like. The use of nickel oxide and nickel as the electron-conductive substance is preferable for such reasons as the thermal stability of the chemical reactor during heat treatment, no chemical reaction with the ion-conductive substance, and the ability to decompose nitrogen oxide (the type of gas being treated) at high efficiency. Nickel oxide alone may be used as the electron-conductive substance, but using a mixture of nickel oxide and nickel as the electron-conductive substance is preferable because nitrogen oxides can be decomposed more efficiently. Zirconia that has been stabilized with yttrium oxide or scandium oxide is preferable as the ion-conductive substance because of its excellent electrical and chemical long-term stability.

The ratio between the electron-conductive substance and the ion-conductive substance used for the upper cathode, as the volumetric proportion of the electron-conductive substance, is preferably at least 30% and no more than 70% because, as will be shown in the examples below, the chemical reactor will be able to perform nitrogen oxide emission control more efficiently, and power consumption can be reduced. It is also preferable for the particles of electron-conductive substance and ion-conductive substance to be uniformly dispersed among each other. If the proportion of electron-conductive substance is less than 30%, particles composed of the electron-conductive substance will not be able to come into contact with each other, instead remaining isolated, and this will decrease electron conductivity. If the proportion of electron-conductive substance is over 70%, good electron conductivity will be ensured, but particles composed of the ion-conductive substance will not be able to come into contact with each other, instead remaining isolated, and this will decrease ion conductivity. For nitrogen oxides to be decomposed at high efficiency, the reaction that supplies electrons to the adsorbed nitrogen oxides and ionizes the oxygen atoms, and the reaction that removes the ionized oxygen ions from the adsorption component must proceed smoothly. However, if either the electron conductivity or the ion conductivity decreases, one of these reactions will become rate-determining, making it impossible to decompose nitrogen oxides at high efficiency. If the proportion of electron-conductive substance is at least 30% and no more than 70%, and if the particles are uniformly dispersed in the lower cathode, particles composed of the electron-conductive substance will be able to come into contact with each other, and particles composed of the ion-conductive substance will also be able to come into contact with each other, so there will be no decrease in either electron conductivity or ion conductivity, making possible the highly efficient decomposition of nitrogen oxides, and allowing power consumption to be reduced. If the volumetric proportion of the electron-conductive substance is 50% or less, as shown in the examples below, there will be a particular decrease in the resistance of the chemical reactor, and less applied voltage will be required for nitrogen oxide emission control. Therefore, it is even more preferable for the volumetric proportion of the electron-conductive substance to be at least 30% and no more than 70%. When nickel oxide and zirconia with a sub-micron diameter are used and uniformly mixed, the compositional ratio at which the highest nitrogen oxide removal rate is achieved will be obtained when the electron-conductive substance accounts for 35 vol %. FIG. 4 shows a typical example illustrating the relationship between nitrogen oxide decomposition and the volumetric ratio of these structural phases.

Examples of the electron-conductive substance used for the lower cathode include gold, silver, platinum, palladium, nickel, and other such metals, and cobalt oxide, nickel oxide, copper oxide, lanthanum chromite, lanthanum manganite, lanthanum cobaltite, and other such metal oxides. An oxygen ion-conductive substance can be used preferably as the ion-conductive substance. The oxygen ion-conductive substance can be zirconia stabilized with yttrium oxide or scandium oxide, ceria stabilized with gadolinium oxide or samarium oxide, lanthanum gallate, or the like. The use of platinum and palladium as the electron-conductive substance is preferable for such reasons as the thermal stability of the chemical reactor during heat treatment, and no chemical reaction with the ion-conductive substance. Zirconia that has been stabilized with yttrium oxide or scandium oxide is preferable as the ion-conductive substance because of its excellent electrical and chemical long-term stability.

Any solid electrolyte can be used as long as it has oxygen ion conductivity. There are no particular restrictions on the solid electrolytes with oxygen ion conductivity, but examples include zirconia stabilized with yttrium oxide or scandium oxide, ceria stabilized with gadolinium oxide or samarium oxide, and lanthanum gallate. Of these, zirconia stabilized with yttrium oxide or scandium oxide is preferable because it has high oxygen ion conductivity and mechanical strength and has excellent chemical and electrical long-term stability.

Examples of the electron-conductive substance used for the anode include gold, silver, platinum, palladium, nickel, and other such metals, and cobalt oxide, nickel oxide, copper oxide, lanthanum chromite, lanthanum manganite, lanthanum cobaltite, and other such metal oxides. An oxygen ion-conductive substance can be used preferably as the ion-conductive substance. The oxygen ion-conductive substance can be zirconia stabilized with yttrium oxide or scandium oxide, ceria stabilized with gadolinium oxide or samarium oxide, lanthanum gallate, or the like. The use of platinum and palladium as the electron-conductive substance is preferable for such reasons as the thermal stability of the chemical reactor during heat treatment, and no chemical reaction with the ion-conductive substance. Zirconia that has been stabilized with yttrium oxide or scandium oxide is preferable as the ion-conductive substance because of its excellent electrical and chemical long-term stability.

The ratio between the electron-conductive substance and the ion-conductive substance used for the anode, as the volumetric proportion of the electron-conductive substance, is preferably at least 30% and no more than 70% because the resistance of the chemical reactor can be decreased this way. It is also preferable for the particles of electron-conductive substance and ion-conductive substance to be uniformly dispersed among each other. If the proportion of electron-conductive substance is less than 30%, particles composed of the electron-conductive substance will not be able to come into contact with each other, instead remaining isolated, and electrons supplied from the outside cannot be uniformly supplied to the entire anode, so electron conductivity will decrease and the resistance of the chemical reactor will increase. If the proportion of electron-conductive substance is over 70%, electrons supplied from the outside can be uniformly supplied to the entire anode, but particles composed of the ion-conductive substance will not be able to come into contact with each other, instead remaining isolated, so the oxygen ions produced in the decomposition of the nitrogen oxides cannot be uniformly supplied to the solid electrolyte, which means that electron conductivity will decrease and the resistance of the chemical reactor will increase. If the proportion of electron-conductive substance is at least 30% and no more than 70%, and if the particles are uniformly dispersed in the anode, particles composed of the electron-conductive substance will be able to come into contact with each other, and particles composed of the ion-conductive substance will also be able to come into contact with each other, making it possible for both electrons and oxygen ions to be uniformly dispersed in the entire anode, so there will be no decrease in either electron conductivity or ion conductivity.

As to the method for forming the chemical reactor, when a solid electrolyte is used as a substrate, a method can be employed in which a paste or solution containing the substances that make up the upper cathode, lower cathode, and anode is first prepared, a film of each paste is formed on the substrate by screen printing or coating, and this product is baked. To give as an example a case in which a chemical reactor is formed by screen printing using a flat solid electrolyte substrate, first, a paste containing the substances that make up the lower cathode is applied by screen printing over the solid electrolyte substrate, and then baked. Next, a paste containing the substances that make up the upper cathode is applied by screen printing so as to cover the previously formed lower cathode, and this product is again baked. Finally, a paste containing the substances that make up the anode is applied by screen printing to the other side of the solid electrolyte substrate and baked, which forms a chemical reactor. The method for forming the films is not limited to screen printing and coating, and may instead be a method in which solutions containing the substances that make up the various layers are prepared, and films are formed on the substrate by dip coating or spin coating. Films can also be formed by PVD or CVD. The solid electrolyte is not the only component that can be used as the substrate, and as long as they have enough mechanical strength that they will not be damaged in the process of forming the chemical reactor, the upper cathode, lower cathode, or anode can also be used as the substrate. Also, sheets containing the substances that make up the upper cathode, lower cathode, solid electrolyte, and anode can be produced by a sheet forming method, and these sheets can be joined by compression bonding and baked, allowing a chemical reactor to be formed without the use of a substrate. Of these methods, one in which a solid electrolyte is used as a substrate, pastes containing the various constituent substances are prepared, films are formed by screen printing or coating, and these films are baked, can be used to advantage in that the equipment used is relatively inexpensive, and films can be formed easily, for example.

Examples of suitable forms for the chemical reactor of the present invention include that of a flat sheet, a cylinder, and a honeycomb. In the case of a flat sheet, exhaust gas can be purified by laminating the upper cathode, lower cathode, solid electrolyte, and anode to form a chemical reactor, and disposing the upper cathode so that it comes into contact with the exhaust gas. In the case of a cylinder, when the chemical reactor is formed such that the inside of the cylinder is the lower cathode and the outside is the anode, exhaust gas can be purified by allowing the exhaust gas to pass through the inside of the cylinder. Conversely, when the chemical reactor is formed such that the outside of the cylinder is the lower cathode and the inside is the anode, exhaust gas can be purified by allowing the exhaust gas to pass over the outside of the cylinder. This chemical reactor is not limited to being used by itself, and disposing a plurality of chemical reactors in series, in parallel, or in series and parallel with respect to the flow of the gas is favorable in that a larger amount of nitrogen oxides can be decomposed.

A chemical reactor produced in this manner is disposed so that the upper cathode will come into contact with exhaust gas containing nitrogen oxides, leads taken off from the lower cathode and the anode are connected to an external power supply, and DC voltage is applied, which causes the oxygen ions produced in the decomposition of the nitrogen oxide at the upper cathode to move through the lower cathode and the solid electrolyte to the anode, and these oxygen ions are converted into oxygen molecules at the anode, allowing the nitrogen oxides in the exhaust gas to be efficiently decomposed. Voltage is not applied directly to the upper cathode, but external voltage causes the oxygen ions to move from the lower cathode to the solid electrolyte, this lowers the oxygen concentration near the interface between the upper cathode and lower cathode, and an oxygen concentration differential is produced near the interface between the lower cathode and the outer surface of the upper cathode in contact with the exhaust gas, so there is movement of the oxygen ions from the outer surface of the upper cathode to the area near the lower cathode interface so as to compensate for this oxygen concentration differential, and as a result the oxygen ions produced in the decomposition of the nitrogen oxides at the upper cathode go from the lower cathode through the solid electrolyte and the anode and are converted into oxygen molecules.

The second aspect of the present invention will now be described in detail.

As a favorable embodiment of the present invention, the present invention is applied to a system for removing nitrogen oxides, for example. The following description focuses on the structure of this system in the present invention, but the present invention is not limited to this.

The chemical reactor for subjecting a treatment substance to a chemical reaction pertaining to the present invention comprises a chemical reaction layer where the chemical reaction of the treatment substance proceeds, an electrode layer for removing oxygen from the chemical reaction layer, a solid electrolyte layer for moving and removing ionized oxygen from the electrode layer by the action of an electrical field, and an oxidation layer for releasing electrons from the oxygen ions, returning [the ions] to [molecular] oxygen, and releasing [this oxygen] to outside the system. In this case, all or part of the solid electrolyte layer and the oxidation layer can be omitted by integrating each of their functions with the electrode layer or partially adding their functions.

The chemical reaction layer for subjecting a treatment substance to a chemical reaction is preferably equipped with a reduction phase that produces ions by supplying electrons to elements contained in the treatment substance, and an ion-conductive phase that conducts these ions from the reduction phase. Preferably, when the treatment substance contains oxygen, or when oxygen is produced before the reaction or by the reaction, the path by which the treatment substance reaches the chemical reaction layer has a catalyst having an oxygen-reducing action for removing all or part of the oxygen contained in the treatment substance. Even more preferably, all or part of the chemical reaction layer is covered.

Preferably, the treatment substance is nitrogen oxides in a combustion exhaust gas, the nitrogen oxides are reduced into oxygen ions in the reduction phase, and the oxygen ions are conducted in the ion-conductive phase. However, the treatment substance in the present invention is not limited to being nitrogen oxides, and can be any suitable treatment substance. With the chemical reactor of the present invention, for example, carbon dioxide can be reduced into carbon monoxide, a mixed gas of hydrogen and carbon monoxide can be produced from methane, or water and hydrogen can be produced. Therefore, the above-mentioned chemical reactor can be configured as desired according to the treatment substance in question.

The structure and form of the chemical reactor are preferably those of a tube, a flat sheet, a honeycomb, or the like, and it is particularly favorable for there to be one or more through-holes having a pair of openings, such as with a tube or honeycomb form, and for the chemical reaction component to be located in each of these through-holes. Also, an aggregate of microstructures, such as a composite powder, having the structure of a chemical reactor is favorable in terms of increasing reaction efficiency. The present invention is not, however, limited to these.

It is preferable in the present invention for the reduction phase that makes up the chemical reaction layer to be porous and to selectively adsorb the substances that are to be reacted, for example. It is preferable for the reduction phase to be composed of an electroconductive material so that electrons will be supplied to the elements contained in the treatment substance, ions will be produced, and the produced ions will be conducted to the ion-conductive phase. Also, in order to promote the conduction of electrons and ions, it is preferable for the reduction phase to be composed of a substance of mixed conductivity, having the characteristics of both electron conductivity and ion conductivity, or to be composed of a mixture of an electron-conductive substance and an ion-conductive substance. The reduction phase may have a structure in which these substances are laminated in two or more phases. These are not limited, however.

There are no particular restrictions on the electroconductive substance and the ion-conductive substance used for the reduction phase, but examples of the electroconductive substance include platinum, palladium, and other such noble metals, and nickel oxide, cobalt oxide, copper oxide, lanthanum manganite, lanthanum cobaltite, lanthanum chromite, and other such metal oxides. Zeolites, alkaline earth-containing oxides, and the like that selectively adsorb the treatment substance can also be used as the reduction phase. It is preferable to use one or more of the above substances as a mixture of one or more types of ion-conductive substance. The ion-conductive substance can be zirconia stabilized with yttrium oxide or scandium oxide, ceria stabilized with gadolinium oxide or samarium oxide, lanthanum gallate, or the like.

The reduction phase preferably has a structure in which the above substances are laminated in two or more phases. More preferably, the reduction phase has a structure in which two phases are laminated, comprising an electroconductive substance phase composed of platinum or another such noble metal, and a mixed phase of nickel oxide and zirconia that has been stabilized with yttria or scandium oxide. In the present invention, the ion-conductive phase that makes up the chemical reaction layer is composed of a solid electrolyte having ion conductivity. Preferably, the ion-conductive phase is composed of a solid electrolyte having oxygen ion conductivity. There are no particular restrictions on the solid electrolytes with oxygen ion conductivity, but examples include zirconia stabilized with yttria or scandium oxide, ceria stabilized with gadolinium oxide or samarium oxide, and lanthanum gallate. Zirconia stabilized with yttria or scandium oxide is preferable because it has high oxygen ion conductivity and mechanical strength and has excellent chemical and electrical long-term stability.

Next, examples of the electron-conductive substance used for the electrode layer in the present invention include gold, silver, platinum, palladium, nickel, and other such metals, and cobalt oxide, nickel oxide, copper oxide, lanthanum chromite, lanthanum manganite, lanthanum cobaltite, and other such metal oxides. An oxygen ion-conductive substance can be used preferably as the ion-conductive substance. The oxygen ion-conductive substance can be zirconia stabilized with yttrium oxide or scandium oxide, ceria stabilized with gadolinium oxide or samarium oxide, lanthanum gallate, or the like.

The electrode layer needs to provide the function of supplying the current needed for the ionization of oxygen and releasing the ionized oxygen to outside the system, either directly or through the solid electrolyte layer adjacent to the lower part, and therefore the electron-conductive phase that makes up this electrode layer preferably is made of platinum, which has thermal stability during the production and operation of the chemical reactor, does not undergo a chemical reaction with the ion-conductive substance, and has high electron conductivity. Zirconia that has been stabilized with yttrium oxide or scandium oxide, which has excellent electrical and chemical long-term stability, or cerium oxide to which samarium or gadolinium has been added, which has low resistance characteristics, is preferable as the ion-conductive substance.

The ratio between the electron-conductive substance and the ion-conductive substance used for the electrode layer, as the volumetric proportion of the electron-conductive substance, is preferably at least 30% and no more than 70% because, as will be shown in the examples below, the chemical reactor will be able to perform nitrogen oxide emission control more efficiently, and power consumption can be reduced. It is also preferable for the particles of electron-conductive substance and the particles of ion-conductive substance to be uniformly dispersed among each other. If the proportion of electron-conductive substance is less than 30%, particles composed of the electron-conductive substance will not be able to come into contact with each other, instead remaining isolated, and this will decrease electron conductivity.

If the proportion of electron-conductive substance is over 70%, good electron conductivity will be ensured, but particles composed of the ion-conductive substance will not be able to come into contact with each other, instead remaining isolated, and this will decrease ion conductivity. If the proportion of electron-conductive substance is at least 30% and no more than 70%, and if the particles are uniformly dispersed in the lower cathode, particles composed of the electron-conductive substance will be able to come into contact with each other, and particles composed of the ion-conductive substance will also be able to come into contact with each other, so there will be no decrease in either electron conductivity or ion conductivity, making possible the highly efficient decomposition of nitrogen oxides, which allows power consumption to be reduced.

As to the ratio of the electron-conductive substance and the ion-conductive substance, there is an even more preferable volumetric proportion within the above-mentioned range of 30 to 70%, according to the electrical conductivity of each under the operating conditions of the chemical reactor. In most cases, if the volumetric proportion of the ion-conductive substance is 50% or greater, there will be a particular decrease in the resistance of the chemical reactor, and less electrical power will be needed for nitrogen oxide emission control. Because of this, it is preferable for the volumetric proportion of the ion-conductive substance to be at least 50% and no more than 70%.

In order for electrons to be supplied to the chemical reaction layer and ions to be conducted, it is preferable for the electrode layer to be as thin as possible while still having a smooth conduction path. Consequently, the volumetric proportions of the above-mentioned electron conductor and ion conductor is preferably closer to a ratio of 50%/50%, which is suited to the formation of a two-dimensional network, than a ratio of 30%/70%, which is more suited to forming a three-dimensional network. Specifically, if the thickness of the electrode layer is several times the diameter of the constituent particles (such as a film thickness of about 3 microns or less in the case of a mixed layer of sub-micron particles of zirconia and platinum), there is only a narrow range where the two substances have a continuous structure, which limits the proportion to about 50%. As discussed above, the greater is the volumetric proportion of the ion-conductive substance, the lower will be the resistance of the chemical reactor, but in the case of a two-dimensional network, once the proportion of the ion-conductive phase goes over 50%, there is a sharp increase in resistance because of the difficulty of maintaining a network of the electron-conductive substance. Accordingly, it is believed that the volumetric proportion of the ion-conductive phase must be 50% or less. FIG. 6 shows a typical example of two-dimensional network formation, and illustrates the relationship between the volumetric proportion of these constituent phases and the nitrogen oxide decomposition rate.

Next, the solid electrolyte layer can be made of the same material as the ion-conductive substance used for the above-mentioned reduction phase. Any solid electrolyte can be used as long as it is a substance having ion conductivity. For instance, examples of solid electrolytes having oxygen ion conductivity include zirconia stabilized with yttrium oxide or scandium oxide, ceria stabilized with gadolinium oxide or samarium oxide, and lanthanum gallate. However, the solid electrolyte is not limited to these, and any suitable material can be used. Because of the need to reduce the power necessary to operate the chemical reactor, it is preferable for the film to be non-porous and to be as thin as possible.

Next, the oxidation layer contains an electroconductive substance so that electrons will be released from the ions from the ion-conductive phase. In order to promote the conduction of electrons and ions, it is preferable for the oxidation layer to be composed of a substance of mixed conductivity, having the characteristics of both electron conductivity and ion conductivity, or to be composed of a mixture of an electron-conductive substance and an ion-conductive substance. There are no particular restrictions on the electroconductive substance and the ion-conductive substance used for the oxidation layer, but examples of the electroconductive substance include platinum, palladium, and other such noble metals, and nickel oxide, cobalt oxide, copper oxide, lanthanum manganite, lanthanum cobaltite, lanthanum chromite, and other such metal oxides, while examples of the ion-conductive substance include zirconia stabilized with yttria or scandium oxide, ceria stabilized with gadolinium oxide or samarium oxide, and lanthanum gallate.

With the present invention, as discussed above, an oxygen-reducing catalyst can be formed if necessary. This oxygen-reducing catalyst can be in the form of a powder, a film, or the like. A catalyst reaction layer can be constituted by packing a powder into a container having a gas inlet and outlet. The catalyst reaction layer can also be such that an oxide catalyst powder is supported on the surface of a tubular or honeycomb carrier, or an oxygen-reducing catalyst is formed as a porous film on a carrier surface. Preferably, an oxygen-reducing catalyst made in the form of a porous film so as to cover the reduction phase that makes up the chemical reaction layer is used as the catalyst reaction component. The larger is the contact surface area with the treatment substance, the more catalyst reaction active sites there will be, so it is preferable for the oxide catalyst phase to have a large specific surface area, and it is preferable for the particles forming the oxide catalyst powder or oxide catalyst film to be finer.

The chemical reactor of the present invention is characterized by having the above-mentioned chemical reaction layer and an electrode layer that is adjacent to this chemical reaction layer, and as discussed above, a solid electrolyte layer, oxidation layer, oxygen-reducing catalyst component, or the like can be formed as desired on these. For instance, the configuration can be such that lead wires are fixed to the electrode layer and the oxidation layer, these are connected to a DC power supply, DC voltage is applied, and current is passed through. The specific structure and material of these can be suitably selected or designed as dictated by the intended use, with no particular restrictions imposed thereon.

Also, as discussed above, the solid electrolyte layer and oxidation layer can each be integrated with an electrode layer in terms of the structure and function thereof, which allows the formation of these to be omitted as desired. Since a chemical reactor needs to require as little power as possible to operate, it is important for the film to be made as thin as possible, and this can be accomplished as above.

The present invention relates to a chemical reactor for subjecting a treatment substance to a chemical reaction, comprising an electrode layer that is adjacent to the chemical reaction layer where the chemical reaction of the treatment substance proceeds. With the present invention, the above-mentioned electrode layer is constituted by an electron-conductive phase with the function of conducting electrons given to the chemical reaction layer in order to ionize elements contained in the treatment substance, and an ion-conductive phase with the function of conducting elements ionized by the chemical reaction. As a result, the electrode layer produces ions by supplying electrons to elements contained in the treatment substance through the electron-conductive phase, and ionizing these elements at the chemical reaction layer, and also makes possible the efficient releases of these ions to outside the system through the ion-conductive phase.

Specifically, this electrode layer has the functions of supplying electrons to the elements that serve as the active sites of the chemical reaction, and allowing the ionized elements to be efficiently moved and removed. This makes it possible to lower the internal resistance in the chemical reactor, and treat the treatment substance at high efficiency and low power consumption. Thus, the present invention provides a chemical reactor with which the power consumption needed to decompose nitrogen oxides, for example, can be reduced, and nitrogen oxide emission control can be performed at high efficiency and low power consumption with an electrochemical cell type of chemical reactor, by optimizing the structures of the path for supplying electrons that ionize elements in the chemical reaction layer and of the path for eliminating ionized elements from the catalyst reaction surface.

With the present invention, the volumetric proportions of the ion-conductive substance and the electron-conductive substance, which are the components that make up the ion-conductive phase and electron-conductive phase constituting the electrode layer, is set to a specific range of 30 to 70%, and the particles of these substances are uniformly dispersed as shown in the examples given below, with the result being a specific decrease in the internal resistance of the chemical reactor, and a marked reduction in the power needed for nitrogen oxide emission control, for example. The present invention proves that the internal resistance of a chemical reactor is markedly lowered by optimizing the structures of the ion conductor and electron conductor in the electrode layer of the chemical reactor, and that this allows nitrogen oxide emission control to be performed at higher efficiency and lower power consumption, and is useful as a way to achieve the practical implementation of an electrochemical cell type of chemical reactor.

The third aspect of the present invention will now be described in detail.

The method of the present invention is a method for removing nitrogen oxides in an exhaust gas with an electrochemical cell that decomposes or removes nitrogen oxide, wherein exhaust gas from a combustor is pretreated in advance with a nitrogen oxide adsorption material that adsorbs nitrogen oxides at low temperatures until the temperature of the exhaust gas rises, and releases nitrogen oxides at high temperatures after the temperature of the exhaust gas has risen, and this pretreated exhaust gas is treated with an electrochemical cell. Also, the present invention is a nitrogen oxide removal system, wherein a nitrogen oxide adsorption component composed of a nitrogen oxide adsorption material is provided at the upstream part of an electrochemical cell that decomposes or removes nitrogen oxides in an electrochemical cell component made up of said electrochemical cell.

The above-mentioned nitrogen oxide adsorption material is one with the functions of adsorbing nitrogen oxides at low temperatures from room temperature up to the operating temperature of the electrochemical cell, and releasing nitrogen oxides at high temperatures over this operating temperature, and preferably, for example, is a nitrogen oxide adsorption material that adsorbs nitrogen oxides at low temperatures from room temperature up to 400° C., and releases nitrogen oxides at high temperatures over 400° C. Specifically, when the temperature of an exhaust gas immediately after the start-up of a combustor is between room temperature and 400° C., the temperature of the solid electrolyte of the electrochemical cell is low, so its ion conductivity is also low. In view of this, with the present invention, the nitrogen oxides in an exhaust gas are adsorbed by the above-mentioned nitrogen oxide adsorption material at low temperatures from room temperature up to 400° C., and the nitrogen oxides adsorbed to the nitrogen oxide adsorption material are released at high temperatures where the temperature of the exhaust gas goes over 400° C., and as a result, the temperature of the solid electrolyte of the electrochemical cell is also raised by the heat involved in this process, the ion conductivity of the solid electrolyte rises, and nitrogen oxides can be decomposed, so at this stage the nitrogen oxides released from the above-mentioned nitrogen oxide adsorption material are decomposed by the electrochemical cell.

Favorable examples of the nitrogen oxide adsorption material used for the above-mentioned nitrogen oxide adsorption component in the present invention include activated carbon, zeolite, silica gel, alkali metal-containing silica or alumina, alkaline earth metal-containing silica or alumina, basic diatomaceous earth, alkaline earth metal-containing copper oxide and iron oxide, transition metal-containing zirconia, and manganese oxide compounds. However, the nitrogen oxide adsorption material of the present invention is not limited to these, and any material that adsorbs nitrogen oxides at the specified temperature and releases nitrogen oxides at the specified temperature can be similarly used. Also, a nitrogen oxide adsorption material having the desired adsorption and release characteristics can be created and used in the present invention by combining these materials as needed.

Favorable examples of the form of the nitrogen oxide adsorption material used in the above-mentioned nitrogen oxide adsorption component of the present invention include a powder, a porous material, a foam, and a honeycomb, but other forms are also possible. In the case of a powder, the adsorption material can be used, for example, by being supported on a ceramic honeycomb or a metal honeycomb. Similarly, in the case of a porous material or a foam, these can be pulverized and supported on a honeycomb, but the usage form is not limited to these. With the present invention, the above-mentioned electrochemical cell is made up of at least three layers: the anode, cathode, and solid electrolyte of the oxygen ion conductor, but any cell can be used as long as it has the function of electrochemically reducing nitrogen oxides into nitrogen and oxygen when voltage is applied between these electrodes. The decomposition of nitrogen oxides by this electrochemical cell is a function of the oxygen ion conductivity of the solid electrolyte being used, and with the above-mentioned electrochemical cell, for example, oxygen ion conductivity will be high enough for sufficient decomposition of nitrogen oxides when the temperature is over 400° C. However, at low temperatures where the exhaust gas immediately after start-up of the combustor is 400° C. or lower, the oxygen ion conductivity of the solid electrolyte is too low for sufficient decomposition of nitrogen oxides. Further, with the present invention, The nitrogen oxide adsorption material should be selected after taking into account the operating temperature of the electrochemical cell being used, so that the material has a function of adsorbing and releasing nitrogen oxides in an exhaust gas that is suitable to this operating temperature.

There are no particular restrictions on the solid electrolyte material of the oxygen ion conductor used in the above-mentioned electrochemical cell component in the present invention, as long as it has oxygen ion conductivity, but preferable examples include zirconia stabilized with yttrium oxide or scandium oxide, ceria stabilized with gadolinium oxide or samarium oxide, and lanthanum gallate. Also, there are no particular restrictions on the cathode material used for the above-mentioned electrochemical cell component in the present invention, as long as it has electron conductivity, but preferable examples include gold, silver, platinum, palladium, nickel, and other such metals, and cobalt oxide, nickel oxide, copper oxide, lanthanum chromite, lanthanum manganite, lanthanum cobaltite, and other such metal oxides. These may also be a mixture of an electron-conductive substance and an ion-conductive substance, or may have a laminated structure.

Further, there are no particular restrictions on the anode material used for the above-mentioned electrochemical cell component in the present invention, as long as it has electron conductivity, but preferable examples include gold, silver, platinum, palladium, nickel, and other such metals, and cobalt oxide, nickel oxide, copper oxide, lanthanum chromite, lanthanum manganite, lanthanum cobaltite, and other such metal oxides. These may also be a mixture of an electron-conductive substance and an ion-conductive substance, or may have a laminated structure.

The electrochemical cell component and the nitrogen oxide adsorption component constituting the nitrogen oxide removal system of the present invention are preferably linked with an exhaust pipe, for example. In this case, the spacing between the electrochemical cell component and the nitrogen oxide adsorption component linked by the exhaust pipe can be adjusted as needed according to the temperature distribution of the exhaust gas. Also, depending on the temperature of the exhaust gas, the nitrogen oxide adsorption component and the electrochemical cell component may be housed in a unit of the same chamber and formed integrally, and there are no particular restrictions on the construction of these components. Also, there are no particular restrictions on the specific configuration of these, and the design can be varied as desired and as dictated by the intended use.

The present invention is characterized in that exhaust gas from a combustor is pretreated in advance with a nitrogen oxide adsorption material that adsorbs nitrogen oxides at low temperatures until the temperature of the exhaust gas rises, and releases nitrogen oxides at high temperatures after the temperature of the exhaust gas has risen, and this pretreated exhaust gas is then treated with an electrochemical cell. With the present invention, the result of employing this constitution is that nitrogen oxides in the exhaust gas are adsorbed by the nitrogen oxide adsorption material when the exhaust gas is cold immediately after the combustor has been started up, the nitrogen oxides are released from the adsorption material at the point when the exhaust gas temperature rises to the operating temperature of the electrochemical cell, and this reliably removes the nitrogen oxides in the exhaust gas immediately after the start-up of the combustor. Wit the present invention, a nitrogen oxide adsorption material having the specified nitrogen oxide adsorption and release characteristics is suitably selected and used, so that the nitrogen oxides in an exhaust gas from a combustor can be removed at high efficiency and high precision even while the exhaust gas is cold immediately after the start-up of the combustor, so the release of nitrogen oxides is suppressed right from the start-up of the combustor.

The fourth aspect of the present invention will now be described in detail.

The present invention relates to a chemical reactor that includes an ion-conductive phase composed of a solid electrolyte for subjecting a treatment substance to a chemical reaction, wherein an ionization reaction inhibition layer that inhibits the ionization reaction of adsorbed oxygen on the surface of a chemical reaction component where the chemical reaction of the treatment substance proceeds is formed on the chemical reaction component surface. In the present invention, the chemical reactor for subjecting a treatment substance to a chemical reaction preferably comprises a chemical reaction component where the chemical reaction of the treatment substance proceeds, and a surface coating layer that inhibits the ionization reaction of adsorbed oxygen.

The chemical reactor for subjecting a treatment substance to a chemical reaction preferably comprises a reduction phase that produces ions by supplying electrons to elements contained in the treatment substance, an ion-conductive phase that conducts these ions from the reduction phase, and an oxidation phase that releases electrons from the ions conducted through this ion-conductive phase.

With the present invention, the treatment substance is preferably nitrogen oxides in a combustion exhaust gas, the nitrogen oxides are reduced into oxygen ions in the reduction phase of the above-mentioned chemical reaction component, the oxygen ions are conducted in the ion-conductive phase, and electrons are released from these ions in the oxidation phase. However, the treatment substance in the present invention is not limited to nitrogen oxides, and the present invention can be applied to other treatment substances as desired. In addition to the above method of treating nitrogen oxides, examples of the reaction method that can be conducted with the chemical reactor of the present invention also include a method in which carbon dioxide is reduced into carbon monoxide, a method in which a mixed gas of hydrogen and carbon monoxide is produced from methane, and a method in which hydrogen is produced from water, although the present invention is not limited to these.

Examples of the form of the chemical reactor include that of a tube, a flat sheet, and a honeycomb, but it is particularly favorable for there to be one or more through-holes having a pair of openings, such as with a tube or honeycomb form, and for the chemical reaction component to be located in each of these through-holes. However, the form of the chemical reactor of the present invention is not limited to these, and can be designed as desired and as dictated by the intended use.

It is preferable for the reduction phase of the chemical reaction component to be porous and to selectively adsorb the treatment substances that are to be reacted, for example. It is preferable for the reduction phase to be composed of an electroconductive material so that electrons will be supplied to the elements contained in the treatment substance, ions will be produced, and the produced ions will be conducted to the ion-conductive phase. Also, in order to promote the conduction of electrons and ions, it is preferable for the reduction phase to be composed of a substance of mixed conductivity, having the characteristics of both electron conductivity and ion conductivity, or to be composed of a mixture of an electron-conductive substance and an ion-conductive substance. The reduction phase may have a structure in which these substances are laminated in two or more phases.

There are no particular restrictions on the electroconductive substance and the ion-conductive substance used for the reduction phase, but examples of the electroconductive substance include platinum, palladium, and other such noble metals, and nickel oxide, cobalt oxide, copper oxide, lanthanum manganite, lanthanum cobaltite, lanthanum chromite, and other such metal oxides. Barium-containing oxides, zeolites, and the like that selectively adsorb the treatment substance can also be used as the reduction phase. It is preferable to use one or more of the above substances as a mixture of one or more types of ion-conductive substance. The ion-conductive substance can be zirconia stabilized with yttrium oxide or scandium oxide, ceria stabilized with gadolinium oxide or samarium oxide, lanthanum gallate, or the like. The reduction phase preferably has a structure in which the above substances are laminated in two or more phases. More preferably, for example, the reduction phase has a structure in which two phases are laminated, comprising an electroconductive substance phase composed of platinum or another such noble metal, and a mixed phase of nickel oxide and zirconia that has been stabilized with yttria or scandium oxide.

The ion-conductive phase of the above-mentioned chemical reaction component is composed of a solid electrolyte having ion conductivity, and preferably is composed of a solid electrolyte having oxygen ion conductivity. There are no particular restrictions on the solid electrolytes with oxygen ion conductivity, but examples include zirconia stabilized with yttria or scandium oxide, ceria stabilized with gadolinium oxide or samarium oxide, and lanthanum gallate. Zirconia stabilized with yttria or scandium oxide is preferable because it has high oxygen ion conductivity and mechanical strength and has excellent long-term stability.

The oxidation phase of the chemical reaction component contains an electroconductive substance in order to release electrons from the ions from the ion-conductive phase, and to promote the conduction of electrons and ions, it is preferable for the oxidation layer to be composed of a substance of mixed conductivity, having the characteristics of both electron conductivity and ion conductivity, or to be composed of a mixture of an electron-conductive substance and an ion-conductive substance. There are no particular restrictions on the electroconductive substance and the ion-conductive substance used for the oxidation layer, but examples of the electroconductive substance include platinum, palladium, and other such noble metals, and nickel oxide, cobalt oxide, copper oxide, lanthanum manganite, lanthanum cobaltite, lanthanum chromite, and other such metal oxides, while examples of the ion-conductive substance include zirconia stabilized with yttria or scandium oxide, ceria stabilized with gadolinium oxide or samarium oxide, and lanthanum gallate.

Next, the ionization reaction inhibition layer or surface coating layer of the above-mentioned chemical reactor has a structure and material that inhibit electrons supplied by the chemical reaction component, and particularly by its reduction phase, from reaching the surface in order to prevent the supply of electrons needed to produce oxygen ions when oxygen molecules have been adsorbed at the surface. This ionization reaction inhibition layer or surface coating layer is preferably an ion conductor, a mixed conductor, or an insulator. In the case of a mixed conductor, the electron conduction inhibition effect will be diminished if the electron conductivity is high, so it is preferable for the proportion of electron conductivity to be as low as possible. Also, this ionization reaction inhibition layer or surface coating layer needs to combine stability with respect to redox environments at high temperature, with a density that allows the suitable supply of treatment substance to the chemical reaction component (the theoretical density ratio at which the production of continuous open pores is possible, is preferably approximately 95% or less, and the theoretical density ratio which is the upper limit at which the increase in power consumption by the adsorption and ionization of oxygen will pose no problem in the operating efficiency of the cell is preferably approximately 80% or higher), so this material is preferably yttria-stabilized zirconia.

In addition, scandium oxide-stabilized zirconia or lanthanum gallate can be used favorably as the material of the above-mentioned ionization reaction inhibition layer or surface coating layer, and a ceria-based ion conductor can similarly be used, although the environmental stability will be inferior. The material, however, is not limited to these. It is also possible to use alumina or the like as an insulator, but structural defects such as interlayer separation will occur if there is a great difference in the thermal expansion characteristics between this material and the adjacent layer. As long as the conditions as the above-mentioned ionization reaction inhibition layer or surface coating layer are met, individual compounds of ion conductors, mixed conductors, and insulators, and composites of these, can also be used. These layers can be formed by a suitable means, such as screen printing or heat treatment, and there are no particular restrictions on this means.

Also, the ionization reaction inhibition layer or surface coating layer does not necessarily have to be located on the uppermost layer surface, and as long as it is capable of inhibiting or blocking the conduction path of the ionization current, it can be in another suitable location, such as an intermediate layer or a mixed layer. However, in the case of a disposition such as this, current consumption caused by the production of oxygen ions when oxygen molecules are adsorbed may be inevitable above these layers, or in regions contiguous from above, so it is more efficient to use a surface coating layer. Also, in this case, the further addition of layer for adsorbing oxygen or other gas molecules, a layer for reducing the oxygen partial pressure with a hydrocarbon, a layer for protecting the electrochemical cell, or the like above the surface coating layer can be employed as desired without hampering the anticipated performance of the present invention in any way.

The present invention relates to a chemical reactor that includes an ion-conductive phase composed of a solid electrolyte for subjecting a treatment substance to a chemical reaction, wherein an ionization reaction inhibition layer that inhibits the ionization reaction of adsorbed oxygen on the surface of a chemical reaction component where the above-mentioned chemical reaction proceeds is formed on an upstream layer of the chemical reaction component. With the present invention, an ionization reaction inhibition layer having a structure and material for blocking the electrical conduction path by which the current supplied from the outside to the chemical reaction component reaches the adsorption point of the oxygen molecules when oxygen gas molecules contained in the treatment substance have been adsorbed on the chemical reaction component surface, is formed on an upstream layer of the chemical reaction component, and the result of this constitution is that the ionization reaction of adsorbed oxygen can be inhibited, and this reduces the current needed for ionization of adsorbed oxygen, and allows nitrogen oxides or another treatment substance to be treated at higher efficiency and lower power consumption.

### BRIEF DESCRIPTION OF THE DRAWINGS

FIG. 1 is a cross section of a flat chemical reactor pertaining to an embodiment of the present invention;

FIG. 2 is a cross section of a cylindrical chemical reactor pertaining to an embodiment of the present invention;

FIG. 3 is a cross section of another cylindrical chemical reactor pertaining to an embodiment of the present invention;

FIG. 4 is a graph of the relationship between the volumetric percentage of nickel oxide and nitrogen oxide decomposition;

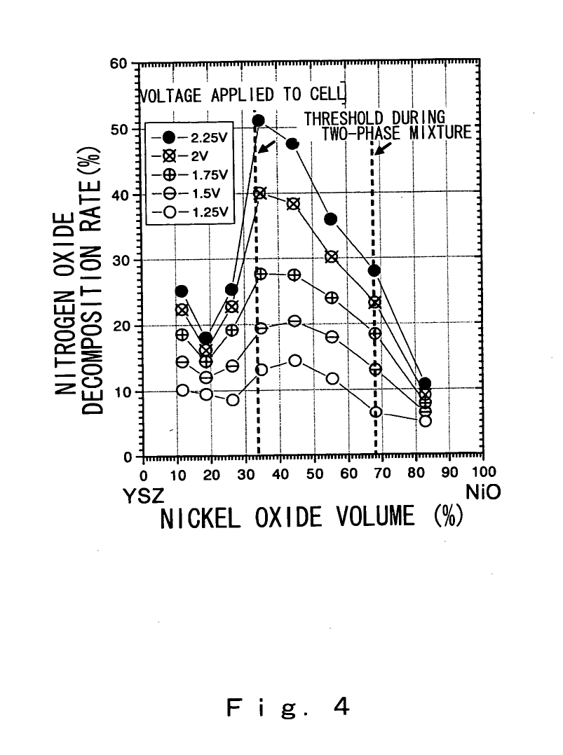

FIG. 5 is a structural diagram of a chemical reactor pertaining to an embodiment of the present invention;

FIG. 6 is a graph of the relationship between the volumetric percentage of zirconia and nitrogen oxide decomposition;

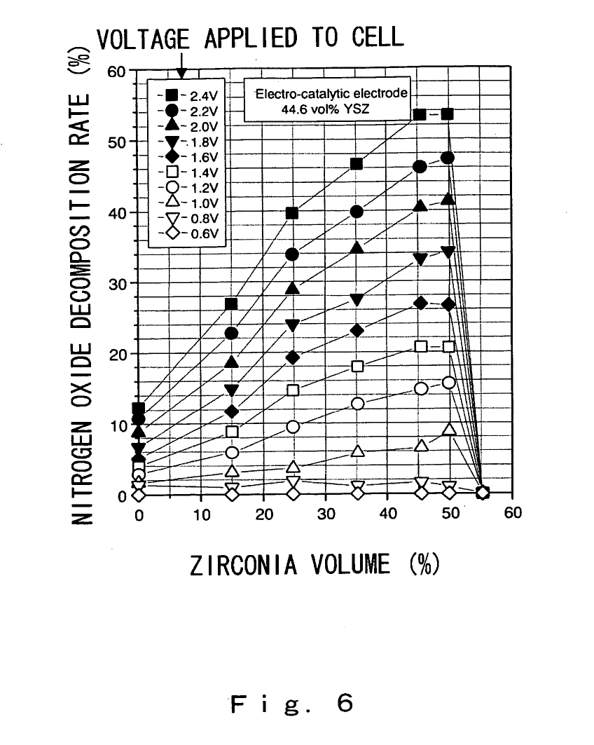

FIG. 7 is an example of a system configuration diagram for the nitrogen oxide removal system composed of the nitrogen oxide adsorption component and electrochemical cell component of the present invention; and

FIG. 8 is a cross section of the structure of a chemical reactor pertaining to an embodiment of the present invention.

### BEST MODE FOR CARRYING OUT THE INVENTION

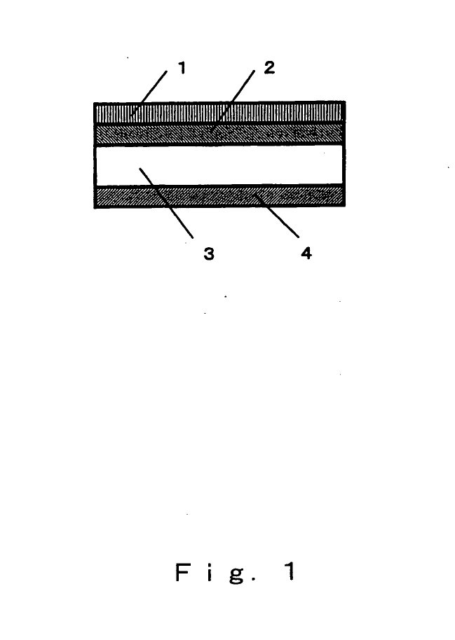

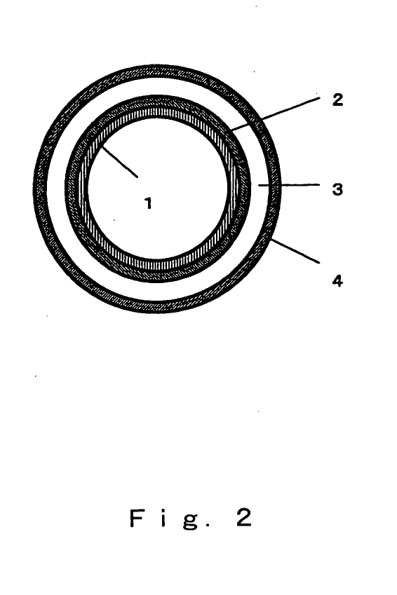

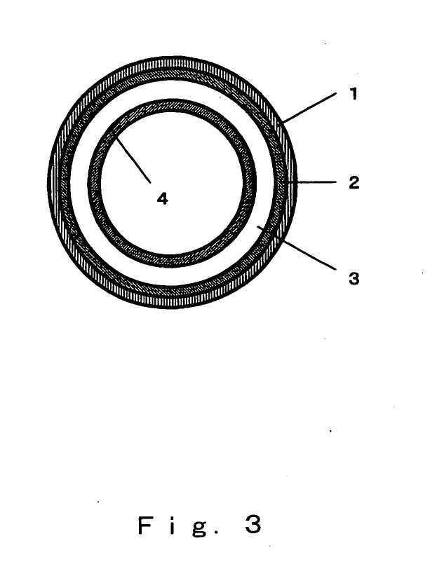

Examples of a first embodiment of the present invention will now be described through reference to the drawings. FIG. 1 is a cross section of a flat chemical reactor pertaining to an embodiment of the present invention. A lower cathode 2 and an upper cathode 1 are formed on one side of a solid electrolyte 3 having oxygen ion conductivity, and an anode 4 is formed on the other side. The lower cathode 2 is disposed between the solid electrolyte 3 and the upper cathode 1 so as to be in contact with both the solid electrolyte 3 and the upper cathode 1. FIGS. 2 and 3 are cross sections of a cylindrical chemical reactor pertaining to an embodiment of the present invention. In FIG. 2, the lower cathode 2 and the upper cathode 1 are formed around the inner peripheral surface of a cylindrical solid electrolyte 3 having oxygen ion conductivity, and the anode 4 is formed around the outer peripheral surface. The lower cathode 2 is disposed between the solid electrolyte 3 and the upper cathode 1 so as to be in contact with both the solid electrolyte 3 and the upper cathode 1. In FIG. 3, the lower cathode 2 and the upper cathode 1 are formed around the outer peripheral surface of a cylindrical solid electrolyte 3 having oxygen ion conductivity, and the anode 4 is formed around the inner peripheral surface. The lower cathode 2 is disposed between the solid electrolyte 3 and the upper cathode 1 so as to be in contact with both the solid electrolyte 3 and the upper cathode 1. Regardless of whether the chemical reactor is flat or cylindrical in shape, the upper cathode is disposed so as to come into contact with an exhaust gas containing nitrogen oxides. Leads are taken out from the lower cathode and the anode and connected to an external power supply, DC and voltage is applied so that there will be a negative potential on the lower cathode side and a positive potential on the anode side, which results in the nitrogen oxides being decomposed at the upper cathode.

### EXAMPLE 1

Zirconia stabilized with yttrium oxide was used as the solid electrolyte 3 having ion conductivity, and the shape thereof was that of a disk with a diameter of 20 mm and a thickness of 0.5 mm. The lower cathode 2 was formed by first producing a paste by adding an organic solvent to a mixed powder of an electron-conductive substance composed of platinum and an ion-conductive substance composed of zirconia stabilized with yttrium oxide, with the mixing ratio (volumetric ratio) being 60:40, and then applying this paste by screen printing to one side of the solid electrolyte 3 such that the surface area was approximately 1.8 cm², and then heat treating this product at 1200° C. The upper cathode 1 was formed by first producing a paste by adding an organic solvent to a mixed powder of an electron-conductive substance composed of nickel oxide and nickel and an ion-conductive substance composed of zirconia stabilized with yttrium oxide, with the mixing ratio (volumetric ratio) being 30.5:69.5, and then applying this paste by screen printing over the lower cathode 2 in the same surface area as the lower cathode, and then heat treating this product at 1500° C. The anode 4 was formed by first producing a paste by adding an organic solvent to a mixed powder of an electron-conductive substance composed of platinum and an ion-conductive substance composed of zirconia stabilized with yttrium oxide, with the mixing ratio (volumetric ratio) being 60:40, and then applying this paste by screen printing to the other side of the solid electrolyte 3 on which the upper cathode 1 and the lower cathode 2 are formed, such that the surface area was approximately 1.8 cm², and then heat treating this product at 1200° C. This resulted in a chemical reactor.

The method for nitrogen oxide emission control using the chemical reactor of the present invention formed in this manner will now be described. The chemical reactor was disposed in a treatment gas, platinum wires were fixed as lead wires to the lower cathode 2 and the anode 4, these leads were connected to a DC power supply, and DC voltage was applied so that current passed through. The nitrogen oxide decomposition and emission control characteristics were evaluated at temperatures between 600 and 650° C. As the treatment gas, a model combustion exhaust gas composed of 1000 ppm nitrogen monoxide and the balance helium containing 3% oxygen was introduced at a flow rate of 50 mL/min. The nitrogen oxide concentration in the treatment gas before and after the model combustion exhaust gas passed through the chemical reactor was measured with a chemiluminescence type of NOx meter, the nitrogen and oxygen concentrations were measured by gas chromatography, and the nitrogen oxide emission control rate was calculated from the reduction in nitrogen oxides. Table 1 shows the nitrogen oxide emission control rate when the chemical reactor was heated to 650° C. and 0.4 W of electric power was applied, and the nitrogen oxide emission control rate when the chemical reactor was heated to 650° C. and 600° C. and a voltage of 2.25 V was applied.

### EXAMPLE 2

A chemical reactor was produced in the same manner as in Example 1, except that the mixing ratio (volumetric ratio) of the electron-conductive substance and ion-conductive substance of the upper cathode 1 was changed to 35.0:65.0. The nitrogen oxide emission control characteristics of this chemical reactor were evaluated in the same manner as in Example 1, the results of which are given in Table 1.

### EXAMPLE 3

A chemical reactor was produced in the same manner as in Example 1, except that the mixing ratio (volumetric ratio) of the electron-conductive substance and ion-conductive substance of the upper cathode 1 was changed to 44.6:55.4. The nitrogen oxide emission control characteristics of this chemical reactor were evaluated in the same manner as in Example 1, the results of which are given in Table 1.

### EXAMPLE 4

A chemical reactor was produced in the same manner as in Example 1, except that the mixing ratio (volumetric ratio) of the electron-conductive substance and ion-conductive substance of the upper cathode 1 was changed to 55.6:44.4. The nitrogen oxide emission control characteristics of this chemical reactor were evaluated in the same manner as in Example 1, the results of which are given in Table 1.

### EXAMPLE 5

A chemical reactor was produced in the same manner as in Example 1, except that the mixing ratio (volumetric ratio) of the electron-conductive substance and ion-conductive substance of the upper cathode 1 was changed to 69.5:30.5. The nitrogen oxide emission control characteristics of this chemical reactor were evaluated in the same manner as in Example 1, the results of which are given in Table 1.

### EXAMPLE 6

Zirconia stabilized with scandium oxide was used as the solid electrolyte 3 having ion conductivity, and the shape thereof was that of a disk with a diameter of 20 mm and a thickness of 0.5 mm. The lower cathode 2 was formed by first producing a paste by adding an organic solvent to a mixed powder of an electron-conductive substance composed of platinum and an ion-conductive substance composed of zirconia stabilized with scandium oxide, with the mixing ratio (volumetric ratio) being 60:40, and then applying this paste by screen printing to one side of the solid electrolyte 3 such that the surface area was approximately 1.8 cm², and then heat treating this product at 1200° C. The upper cathode 1 was formed by first producing a paste by adding an organic solvent to a mixed powder of an electron-conductive substance composed of nickel oxide and nickel and an ion-conductive substance composed of zirconia stabilized with scandium oxide, with the mixing ratio (volumetric ratio) being 35.0:65.0, and then applying this paste by screen printing over the lower cathode 2 in the same surface area as the lower cathode, and then heat treating this product at 1500° C. The anode 4 was formed by first producing a paste by adding an organic solvent to a mixed powder of an electron-conductive substance composed of platinum and an ion-conductive substance composed of zirconia stabilized with scandium oxide, with the mixing ratio (volumetric ratio) being 60:40, and then applying this paste by screen printing to the other side of the solid electrolyte 3 on which the upper cathode 1 and the lower cathode 2 are formed, such that the surface area was approximately 1.8 cm², and then heat treating this product at 1200° C. This resulted in a chemical reactor. The nitrogen oxide emission control characteristics of this chemical reactor were evaluated in the same manner as in Example 1, the results of which are given in Table 1.

### COMPARATIVE EXAMPLE 1

A chemical reactor was produced in the same manner as in Example 1, except that the mixing ratio (volumetric ratio) of the electron-conductive substance and ion-conductive substance of the upper cathode 1 was changed to 26.5:73.5. The nitrogen oxide emission control characteristics of this chemical reactor were evaluated in the same manner as in Example 1, the results of which are given in Table 1.

### COMPARATIVE EXAMPLE 2

A chemical reactor was produced in the same manner as in Example 1, except that the mixing ratio (volumetric ratio) of the electron-conductive substance and ion-conductive substance of the upper cathode 1 was changed to 83.6:16.4. The nitrogen oxide emission control characteristics of this chemical reactor were evaluated in the same manner as in Example 1, the results of which are given in Table 1.

### COMPARATIVE EXAMPLE 3

Zirconia stabilized with yttrium oxide was used as the solid electrolyte 3 having ion conductivity, and the shape thereof was that of a disk with a diameter of 20 mm and a thickness of 0.5 mm. The lower cathode 2 was formed in the same manner as in Example 1. After this, no upper cathode 1 was formed, and the anode 4 was formed in the same manner as in Example 1 on the other side of the solid electrolyte 3 from that where the lower cathode 2 was formed, to produce a chemical reactor. The nitrogen oxide emission control characteristics of this chemical reactor were evaluated in the same manner as in Example 1, the results of which are given in Table 1.

TABLE 1

| | Nitrogen oxide emission control rate | | |
|---|---|---|---|
| | Operating temp. | Operating temp. | Operating temp. |
| | 650° C. | 650° C. | 600° C. |
| | Power consumption | Applied voltage | Applied voltage |
| | 0.4 W | 2.25 V | 2.25 V |
| Example 1 | 41% | 66% | 42% |
| Example 2 | 44% | 66% | 47% |
| Example 3 | 43% | 64% | 43% |
| Example 4 | 41% | 53% | 36% |
| Example 5 | 35% | 41% | 28% |
| Example 6 | 45% | 77% | 50% |
| Comp. Ex. 1 | 28% | 32% | 24% |
| Comp. Ex. 2 | 15% | 12% | 11% |
| Comp. Ex. 3 | 0% | 2% | 0% |

Examples of a second embodiment of the present invention will now be described through reference to the drawings.

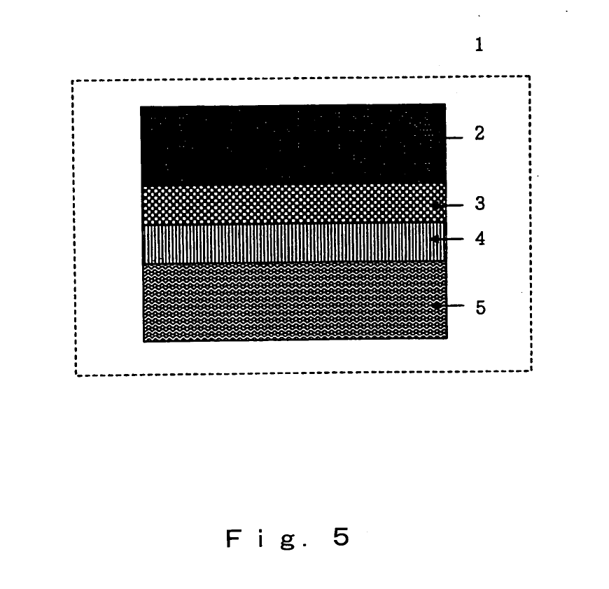

FIG. 5 is a structural diagram of a chemical reactor 1 pertaining to an embodiment of the present invention. An electrode layer 3 is provided between a chemical reaction layer 2 and a solid electrolyte layer 4, in contact with both. An oxidation layer 5 is provided to the opposite side of the solid electrolyte layer 4 from that facing the electrode layer 3. The following is a specific description of when the treatment substance is nitrogen oxide.

### EXAMPLE 7

Zirconia stabilized with yttrium oxide was used as the solid electrolyte 4 having ion conductivity, and the shape thereof was that of a disk with a diameter of 20 mm and a thickness of 0.5 mm. The electrode layer 3 was formed by first producing a paste by adding an organic solvent to a mixed powder of an electron-conductive substance composed of platinum and an ion-conductive substance composed of zirconia stabilized with yttrium oxide, with the mixing ratio (volumetric ratio) being 40:60, and then applying this paste by screen printing to one side of the solid electrolyte 4 such that the surface area was approximately 1.8 cm², and then heat treating this product at 1200° C.

The chemical reaction layer 2 was formed by first producing a paste by adding an organic solvent to a mixed powder of an electron-conductive substance composed of nickel oxide and nickel and an ion-conductive substance composed of zirconia stabilized with yttrium oxide, with the mixing ratio (volumetric ratio) being 40:60, and then applying this paste by screen printing over the electrode layer 3 in the same surface area as the lower cathode, and then heat treating this product at 1500° C.

The oxidation layer 5 was formed by first producing a paste by adding an organic solvent to a mixed powder of an electron-conductive substance composed of platinum and an ion-conductive substance composed of zirconia stabilized with yttrium oxide, with the mixing ratio (volumetric ratio) being 60:40, and then applying this paste by screen printing to the other side of the solid electrolyte 4 on which the chemical reaction layer 2 and the electrode layer 3 are formed, such that the surface area was approximately 1.8 cm², and then heat treating this product at 1200° C. This resulted in a chemical reactor.

An example of the method for nitrogen oxide emission control using the chemical reactor of the present invention formed in this manner will now be given. The chemical reactor was disposed in a treatment gas, platinum wires were fixed as lead wires to the electrode layer 3 and the oxidation layer 5, these leads were connected to a DC power supply, and DC voltage was applied so that current passed through. The nitrogen oxide decomposition and emission control characteristics were evaluated at temperatures between 600 and 700° C.

As the treatment gas, a model combustion exhaust gas composed of 1000 ppm nitrogen monoxide and the balance helium containing 2% oxygen was introduced at a flow rate of 50 mL/min. The nitrogen oxide concentration in the treatment gas before and after the model combustion exhaust gas passed through the chemical reactor was measured with a chemiluminescence type of NOx meter, the nitrogen and oxygen concentrations were measured by gas chromatography, and the nitrogen oxide emission control rate was calculated from the reduction in nitrogen oxides. The electrical power needed to obtain a nitrogen oxide emission control rate of 50% when the chemical reactor was heated to 600° C. was 0.25 W.

### EXAMPLE 8

A chemical reactor was produced in the same manner as in Example 7, except that the mixing ratio (volumetric ratio) of the electron-conductive substance and ion-conductive substance of the electrode layer was changed to 45.0:55.0. The nitrogen oxide emission control characteristics of this chemical reactor were evaluated in the same manner as in Example 7. As a result, the electrical power needed to obtain a nitrogen oxide emission control rate of 50% was 0.21 W.

### EXAMPLE 9

A chemical reactor was produced in the same manner as in Example 7, except that the mixing ratio (volumetric ratio) of the electron-conductive substance and ion-conductive substance of the electrode layer was changed to 31.5:68.5. The nitrogen oxide emission control characteristics of this chemical reactor were evaluated in the same manner as in Example 7. As a result, the electrical power needed to obtain a nitrogen oxide emission control rate of 50% was 0.29 W.

### EXAMPLE 10

A chemical reactor was produced in the same manner as in Example 7, except that the mixing ratio (volumetric ratio) of the electron-conductive substance and ion-conductive substance of the electrode layer was changed to 67.5:32.5. The nitrogen oxide emission control characteristics of this chemical reactor were evaluated in the same manner as in Example 7. As a result, the electrical power needed to obtain a nitrogen oxide emission control rate of 50% was 0.33 W.

### COMPARATIVE EXAMPLE 4

A chemical reactor was produced in the same manner as in Example 7, except that the mixing ratio (volumetric ratio) of the electron-conductive substance and ion-conductive substance of the electrode layer was changed to 25.0:75.0. The nitrogen oxide emission control characteristics of this chemical reactor were evaluated in the same manner as in Example 7. As a result, the electrical power needed to obtain a nitrogen oxide emission control rate of 50% was 0.45 W.

### COMPARATIVE EXAMPLE 5

A chemical reactor was produced in the same manner as in Example 7, except that the mixing ratio (volumetric ratio) of the electron-conductive substance and ion-conductive substance of the electrode layer was changed to 80.0:20.0. The nitrogen oxide emission control characteristics of this chemical reactor were evaluated in the same manner as in Example 7. As a result, even when the operating power of the chemical reactor was raised to 0.8 W, the nitrogen oxide emission control rate was no higher than 35%.

Examples of a third embodiment of the present invention will now be described in specific terms.

### EXAMPLE 11

(1) Configuration of Nitrogen Oxide Removal System

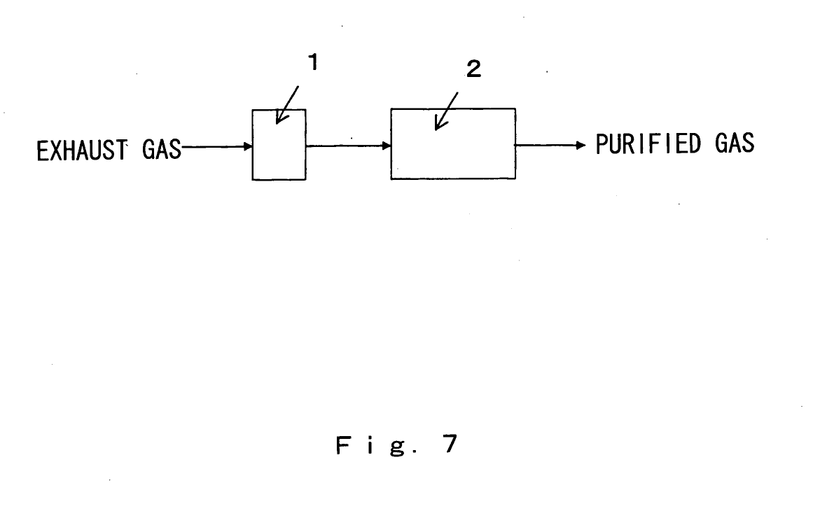

FIG. 7 is a system configuration diagram for the nitrogen oxide removal system composed of the nitrogen oxide adsorption component and electrochemical cell component pertaining to an embodiment of the present invention. The exhaust gas emitted from the combustor passes through a nitrogen oxide adsorption component 1 and is supplied to an electrochemical cell component 2. In the electrochemical cell component 2, nitrogen oxides in the introduced exhaust gas are decomposed and emitted as a purified gas at high temperatures at which the ion conductivity of the solid electrolyte is high. While the temperature of the solid electrolyte in the electrochemical cell component is still low (such as during start-up of the combustor) and the ion conductivity is low, the nitrogen oxides in the exhaust gas emitted from the combustor are adsorbed by the nitrogen oxide adsorption component 1 so as to minimize the emission of nitrogen oxides. When the exhaust gas temperature rises to the operating temperature of the electrochemical cell component 2, the nitrogen oxides adsorbed by the nitrogen oxide adsorption component 1 are released from the nitrogen oxide adsorption component 1. The released nitrogen oxides are supplied to the electrochemical cell component 2 along with the nitrogen oxides in the exhaust gas, and are decomposed in this electrochemical cell component 2 and emitted as purified gas.

(2) Nitrogen Oxide Removal Method

A nitrogen oxide emission control experiment was conducted using a lithium silicate foam as the nitrogen oxide adsorption material of the nitrogen oxide adsorption component 1, using zirconia stabilized with yttrium oxide as the solid electrolyte of the electrochemical cell component 2, using a composite of nickel oxide, nickel, platinum, and zirconia stabilized with yttrium oxide as the cathode, and using platinum and zirconia stabilized with yttrium oxide as the anode. A model exhaust gas composed of 1000 ppm nitrogen monoxide and the balance helium containing 3% oxygen was introduced at a flow rate of 50 mL/min. The electrochemical cell component 2 was capable of nitrogen oxide emission control of 90% or higher at 600° C. under the above conditions. The nitrogen oxide concentration in the outlet gas was measured with a chemiluminescence type of NOx meter while voltage was applied to the electrochemical cell and while the temperature of the system was raised to 600° C. over a period of 10 minutes.

(3) Results

Employing the above configuration yielded a nitrogen oxide emission control rate of 90% or higher even at low temperatures from room temperature up to 400° C. Meanwhile, gas was supplied to the electrochemical cell component 2 directly, without first passing through the nitrogen oxide adsorption component 1, and the same experiment was conducted, and as a result the nitrogen oxide emission control rate was 0% between room temperature and 400° C., and the emission control rate gradually rose at higher temperatures, with the nitrogen oxide emission control rate finally going over 90% when the temperature reached 600° C. These results indicate that the method and system of the present invention are particularly useful as technology for treating nitrogen oxides in exhaust gases while the exhaust gas is still cold immediately after the combustor has been started up.

The fourth aspect of the present invention will now be described in detail.

### EXAMPLE 12

(1) Configuration of Chemical Reactor

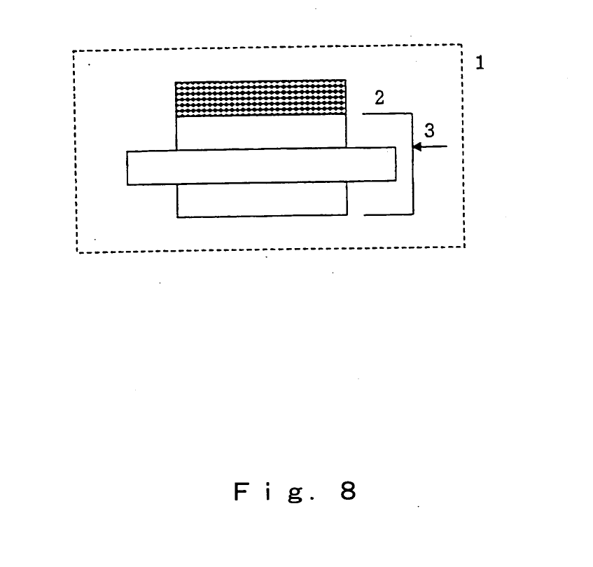

FIG. 8 is a cross section of the structure of a chemical reactor 1 pertaining to an embodiment of the present invention. A surface coating layer 2 is located further upstream than a chemical reaction component 3 in the gas flow. That is, the treatment gas first passes through the surface coating layer 2, and then passes through the chemical reaction component 3.

(2) Production of Chemical Reactor

The following example is for when the treatment substance is nitrogen oxides.

Yttria-stabilized zirconia was used as the solid electrolyte having ion conductivity, and the shape thereof was that of a disk with a diameter of 20 mm and a thickness of 0.3 mm. The reduction phase constituting the chemical reaction component had a two-layer construction comprising a film composed of a mixture of nickel oxide and yttria-stabilized zirconia, and a film composed of platinum and yttria-stabilized zirconia. The film composed of platinum and yttria-stabilized zirconia was formed by screen printing one side of the solid electrolyte such that the surface area was approximately 1.1 cm², and then heat treating this product at 1200° C.

The mixed film of nickel oxide and yttria-stabilized zirconia was formed by screen printing over the platinum film in the same surface area as the platinum film, and then heat treating this product at 1450° C. The mixing ratio (molar ratio) of the nickel oxide and yttria-stabilized zirconia was 3:7. A platinum film was applied by screen printing in a surface area of approximately 1.1 cm² to the other side of the solid electrolyte on which the reduction phase had been formed, after which this product was heat treated at 1200° C. to form an oxidation phase. The surface coating layer was formed on the surface of the above-mentioned reduction phase by screen printing with yttria-stabilized zirconia and baking at 1400° C.

(3) Method for Treating Nitrogen Oxides

The method for treating nitrogen oxides with the chemical reactor of the present invention produced in this manner will now be described. The chemical reactor was disposed in the treatment gas, platinum wires were fixed as lead wires to the reduction phase and the oxidation phase, these leads were connected to a DC power supply, and DC voltage was applied so that current passed through. Evaluation was conducted a reaction temperatures between 500 and 600° C. As the treatment gas, a model combustion exhaust gas composed of 1000 ppm nitrogen monoxide and the balance helium containing 3% oxygen was introduced at a flow rate of 50 mL/min. The nitrogen oxide concentration in the treatment gas before and after the model combustion exhaust gas passed through the chemical reactor was measured with a chemiluminescence type of NOx meter, and the nitrogen and oxygen concentrations were measured by gas chromatography. The nitrogen oxide emission control rate was calculated from the reduction in nitrogen oxides, and the current density and power consumption were measured when the emission control rate was 50%.

(4) Results

The chemical reactor was heated to a reaction temperature of 600° C., and power was switched on to the chemical reaction component. At this point the nitrogen oxide emission control rate increased along with the current flow, and the nitrogen oxide content decreased to approximately 50% at a current density of 55 mA/cm² and a power consumption of 80 mW.

### EXAMPLE 13

A chemical reactor was produced in the same manner as in Example 12, except that gadolinium 10% doped ceria was used as the ion conductor constituting the surface coating layer. This chemical reactor was heated to a reaction temperature of 500° C., and power was switched on to the chemical reaction component. At this point the nitrogen oxide emission-control rate increased along with the current flow, and the nitrogen oxide content decreased to approximately 50% at a current density of 52 mA/cm² and a power consumption of 67 mW.

### INDUSTRIAL APPLICABILITY

As discussed in detail above, the present invention relates to a chemical reactor for performing nitrogen oxide emission control, and the present invention provides a chemical reactor with which nitrogen oxides can be treated at low power consumption, low applied voltage, and high efficiency, even in the presence of an excess of oxygen that hampers nitrogen oxide emission control, and to a method for performing nitrogen oxide emission control at high efficiency using this chemical reactor.

The present invention also relates to a chemical reactor having a specific electrode layer, and to a chemical reaction system that utilizes said electrode layer, and the present invention provides a chemical reactor with which (1) a chemical reactor can be provided that is capable of treating a treatment substance at high efficiency and low power consumption, (2) the structure of the path over which electrons are supplied for ionizing elements in an electrochemical cell type of chemical reactor can be optimized, (3) internal resistance can be sufficiently decreased in an electrochemical cell type of chemical reactor, (4) highly efficient decomposition of nitrogen oxides is possible, and a reduction in power-consumption is also possible, (5) the electrical power needed for nitrogen oxide emission control can be markedly reduced by lowering the internal resistance of a chemical reactor, and (6) a chemical reactor can be provided with which a treatment substance can be treated at high efficiency even in the presence of an excess of oxygen that hampers nitrogen oxide emission control.

The present invention also relates to a method and system for removing nitrogen oxides, and the present invention offers the effects whereby (1) nitrogen oxides can be reliably removed from exhaust gases emitted from combustors, (2) the nitrogen oxides in an exhaust gas can be treated while the exhaust gas is still cold immediately after the combustor has been started up, (3) with the method and system for removing nitrogen oxides of the present invention, nitrogen oxides in the exhaust gas from a combustor such as a lean engine or a diesel engine that is frequently started and stopped can be removed at the time of start-up, and (4) accordingly, the release of nitrogen oxides from a combustor can be reliably suppressed not only during steady Operation, but also during non-steady operation, which results in a markedly lower environmental impact.

Further, the present invention relates to a chemical reactor for nitrogen oxide emission control, and the present invention offers the special effects whereby (1) with a chemical reactor including an ion-conductive phase composed of a solid electrolyte for subjecting a treatment substance to a chemical reaction, the electrical conduction path to the surface of a chemical reaction component that adsorbs oxygen can be blocked, (2) the electrical conduction path by which the current supplied from the outside to the chemical reaction component reaches the adsorption point of the oxygen molecules is blocked, and the ionization reaction of adsorbed oxygen can be inhibited at the chemical reaction component surface, (3) less current is needed for the adsorbed oxygen ionization reaction, so the nitrogen oxides or other treatment substance can be treated at higher efficiency and lower power consumption, (4) power consumption can be markedly reduced in a chemical reactor, and (5) a chemical reactor is provided with which a treatment substance can be treated at high efficiency and low energy consumption even in the presence of an excess of oxygen that hampers nitrogen oxide emission control.

1. A chemical reactor for nitrogen oxide emission control, comprising a electrochemical cell with a four-layer structure consisting of an upper cathode (catalyst reaction component) and a lower cathode (positive electrode) composed of an electron-conductive substance and an ion-conductive substance, a solid electrolyte having oxygen ion conductivity, and an anode (negative electrode), wherein the volumetric ratio of the electron-conductive substance and ion-conductive substance that make up the upper cathode is from 3:7 to 7:3.

2. The chemical reactor according to claim 1, wherein the volumetric ratio of the electron-conductive substance and ion-conductive substance that make up the upper cathode is from 3:7 to 5:5.

3. The chemical reactor according to claim 1 or 2, wherein the electron-conductive substance of the upper cathode is composed of nickel and nickel oxide, and the ion-conductive substance is composed of zirconia stabilized with yttrium oxide or scandium oxide.

4. The chemical reactor according to claim 1, wherein the electron-conductive substance of the lower cathode is composed of platinum and/or palladium, and the ion-conductive substance is composed of zirconia stabilized with yttrium oxide or scandium oxide.

5. The chemical reactor according to claim 1, wherein the solid electrolyte is composed of zirconia stabilized with yttrium oxide or scandium oxide.

6. The chemical reactor according to claim 1, wherein the anode is composed of an electron-conductive substance and an ion-conductive substance, and the volumetric ratio of the electron-conductive substance and ion-conductive substance is from 3:7 to 7:3.

7. The chemical reactor according to claim 7, wherein the electron-conductive substance of the anode is composed of platinum and/or palladium, and the ion-conductive substance is composed of zirconia stabilized with yttrium oxide or scandium oxide.

8. A method for the emission control of nitrogen oxides with the chemical reactor according to any of claims 1 to 7, wherein nitrogen oxides are emission-controlled at the upper cathode by applying voltage between the lower cathode and the anode of the electrochemical cell.

9. A chemical reactor for subjecting a treatment substance to a chemical reaction, comprising a chemical reaction layer where the chemical reaction of the treatment substance proceeds, and an electrode layer that is adjacent to the chemical reaction layer, the electrode layer having the function of conducting electrons to the chemical reaction layer and conducting to outside the system ionized elements produced in the chemical reaction layer.

10. The chemical reactor according to claim 9, wherein the electrode layer is composed of an oxide, a metal, or a mixture of both.

11. The chemical reactor according to claim 9, wherein the electrode layer is composed of an electron-conductive phase that conducts electrons given for ionizing elements contained in the treatment substance in the chemical reaction layer, and an ion-conductive phase that conducts elements ionized by the chemical reaction.

12. The chemical reactor according to claim 9, wherein the mixing ratio of the ion-conductive phase and the electron-conductive phase in the electrode layer is in the range of ion-conductive phase:electron-conductive phase=3:7 to 7:3.

13. The chemical reactor according to claim 9, wherein the treatment substance is a nitrogen oxide, the nitrogen oxide is reduced into oxygen ions in the chemical reaction layer, and the oxygen ions are conducted in the ion-conductive phase of the electrode layer.

14. A method for removing nitrogen oxides in an exhaust gas with an electrochemical cell that decomposes or removes nitrogen oxides, wherein exhaust gas from a combustor is pretreated in advance with a nitrogen oxide adsorption material that adsorbs nitrogen oxides at low temperatures until the temperature of the exhaust gas rises, and releases nitrogen oxides at high temperatures after the temperature of the exhaust gas has risen, and this pretreated exhaust gas is treated with an electrochemical cell.

15. The method for removing nitrogen oxides according to claim 14, wherein pretreatment is performed using a nitrogen oxide adsorption material that adsorbs nitrogen oxides at low temperatures from room temperature up to 400° C., and releases nitrogen oxides at high temperatures over 400° C.

16. A nitrogen oxide removal system, wherein a nitrogen oxide adsorption component composed of a nitrogen oxide adsorption material is provided at the upstream part of an electrochemical cell that decomposes or removes nitrogen oxides in an electrochemical cell component made up of said electrochemical cell.

17. The nitrogen oxide removal system according to claim 16, which is an apparatus for decomposing or removing nitrogen oxides using an electrochemical cell comprising at least three layers, consisting of a solid electrolyte of an oxygen ion conductor, a cathode, and an anode, wherein a nitrogen oxide adsorption component is provided ahead of the gas inlet of said apparatus.

18. The nitrogen oxide removal system according to claim 16, wherein the nitrogen oxide adsorption component is composed of a nitrogen oxide adsorption material that adsorbs nitrogen oxides at low temperatures from room temperature up to 400° C., and releases nitrogen oxides at high temperatures over 400° C.

19. A chemical reactor for subjecting a treatment substance to a chemical reaction, wherein a surface coating layer that inhibits the ionization reaction of adsorbed oxygen on the surface of a chemical reaction component where the chemical reaction of the treatment substance proceeds is formed on said chemical reaction component surface.

20. The chemical reactor according to claim 19, wherein the surface coating layer is composed of an ion-conductive substance, a mixed conductive substance, or an insulating substance.

21. The chemical reactor according to claim 19 or 20, wherein the chemical reaction component is composed of a reduction phase that produces ions by supplying electrons to elements contained in the treatment substance, an ion-conductive phase that conducts these ions from the reduction phase, and an oxidation phase that releases electrons from the ions conducted through this ion-conductive phase.

22. The chemical reactor according to any of claims 19 to 21, wherein the treatment substance is a nitrogen oxide, the nitrogen oxide is reduced into oxygen ions in the reduction phase, and the oxygen ions are conducted in the ion-conductive phase.

23. The chemical reactor according to claim 19 or 20, wherein the ionization reaction inhibition layer or surface coating layer has a structure or material that blocks the conduction path by which current supplied from the outside to the chemical reaction component reaches the adsorption point of oxygen molecules.
